(19) United States
(12) Patent Application Publication
(10) Pub. No.: US 2008/0052019 A1
(43) Pub. Date: Feb. 28, 2008

(54) Compact Data Transmission Protocol for Electric Utility Meters

(76) Inventors: W. J. Brennan, Tallassee, AL (US); Joe Cely, Tallassee, AL (US)

Correspondence Address: BRADLEY ARANT ROSE & WHITE LLP, 200 CLINTON AVE. WEST, SUITE 900, HUNTSVILLE, AL, 35801, US

(21) Appl. No.: 11/467,427

(22) Filed: Aug. 25, 2006

(51) Int. Cl. G06F 19/00; G06F 17/40

(52) U.S. Cl. 702/64; 702/1; 702/57; 702/60; 702/61; 702/187; 702/189; 340/870.01; 340/870.02

(57) ABSTRACT

A communication protocol for compacting data transmissions from electric utility meters has been developed. The present invention is a method of transmitting the utility meter data using the protocol. The protocol includes collecting electric usage data and a voltage level at the utility meter. The usage data and the voltage level are then transmitting in synchronous order the utility receiving station.

### FIELD OF THE INVENTION

The invention relates generally to electric utility meters. More specifically, the present invention relates to data transmission protocols for electric utility meters.

### BACKGROUND ART

Electric utilities use meters to measure and record electricity, usage by their customers. The utilities must read their meters for billing purposes. The readings may be conducted manually by utility personnel or automatically with radio signals, telephone connections, etc. Electric Utilities also have the need to collect other measurements at the electric meter that are not used for billing, such as voltage or other system status readings. For example, a voltage measurement is important because it indicates the quality of the power that is delivered to the customer.

Often when the utility needs this additional information, they must make a special effort to collect it. Further, these measurements often require special equipment and labor to gather. It also can only be collected from that point in time. No historical data is typically available. Consequently, it would be advantageous to collect the additional information such as a voltage reading at the meter, along with the billing information.

### SUMMARY OF THE INVENTION

In some aspects, the invention relates to a method of transmitting electric utility data, comprising: collecting electric usage data at a utility meter; collecting a voltage level at the utility meter; and transmitting the voltage level to a utility receiving station synchronous to the transmission of the electric usage data to a utility receiving station.

Other aspects and advantages of the will be apparent from the following description and the appended claims.

### BRIEF DESCRIPTION OF DRAWINGS

It should be noted that identical features in different drawings are shown with the same reference numeral.

FIG. 1 shows a block diagram of the arrangement of the system meter in accordance with one example of the present invention.

FIG. 2 shows a block diagram of a data transmission that includes consumption, status indicators, and voltage measurements in accordance with one example of the present invention.

FIG. 3 shows a block diagram of a data transmission that includes consumption and voltage measurements in accordance with one example of the present invention.

### DETAILED DESCRIPTION

A compact data transmission protocol for electric utility meters has been developed. The present invention gathers consumption/usage data at the customer's meter that is used for billing purposes. Supplemental information is also gathered at the same time at the meter. Such information includes data not used for billing or by the meter readers such as voltage levels, tamper alarms, error indicators and any other status indicators that are well known to those of skill in the art. The information is collected by the utility along with the billing information, and passed through the same systems as the billing information. The supplemental information may be combined with the usage data into a single combined transmission message. In other embodiments, the supplemental information may be transmitted synchronously (i.e., close in time) to the usage data.

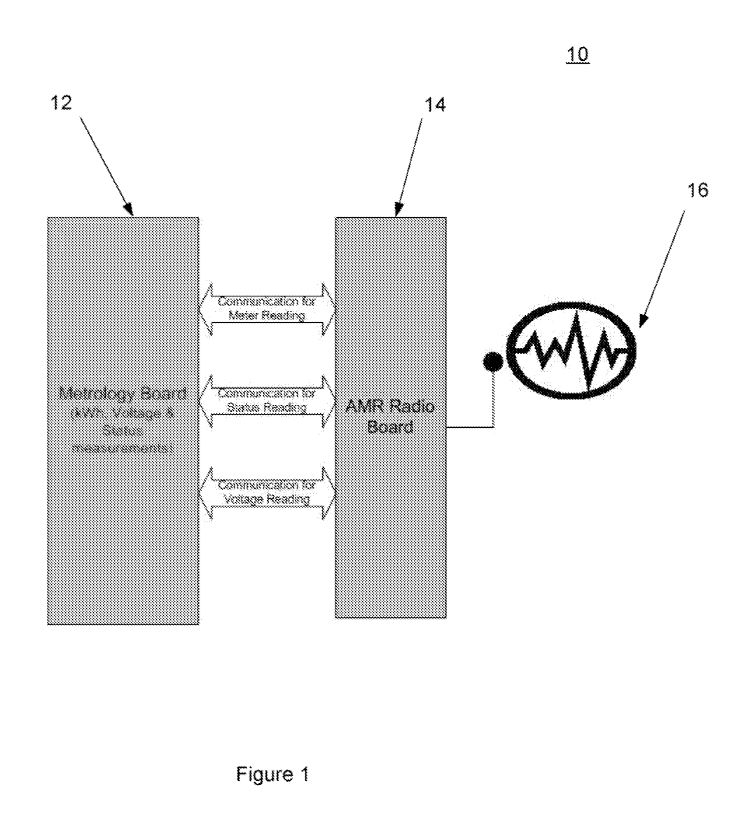

FIG. 1 shows an example an automated meter reading (AMR) unit 10 that is used in the present invention. The unit 10 uses a metrology board 12 to collect the usage data (in kWh), voltage levels, and any other status readings or indicators desired. This data is then transferred to the AMR radio board 14 and transmitted to the utility via radio signals 16. While this example shows a radio for data transmission, other embodiments could use other methods such as a transmission over a telephone line, interrogation by a fixed or mobile receiver, or a manual reading by utility personnel. In some embodiments of the present invention, one piece of equipment may be used to collect all of the desired data from the meter.

The collection of the supplemental data in addition to the usage data has the advantage of providing the utility with a historical record of the supplemental data. Historical data is particularly valuable because voltage information is often only available after the fact (e.g. After the voltage level has gone outside of the normal ranges because of a customer complaint). In some embodiments, the invention collects real time voltage level root mean squared and peak readings at the meter. Additionally, the present invention reduces the need for a special request from the utility to measure such data as voltage which reduces cost and effort to the utility.

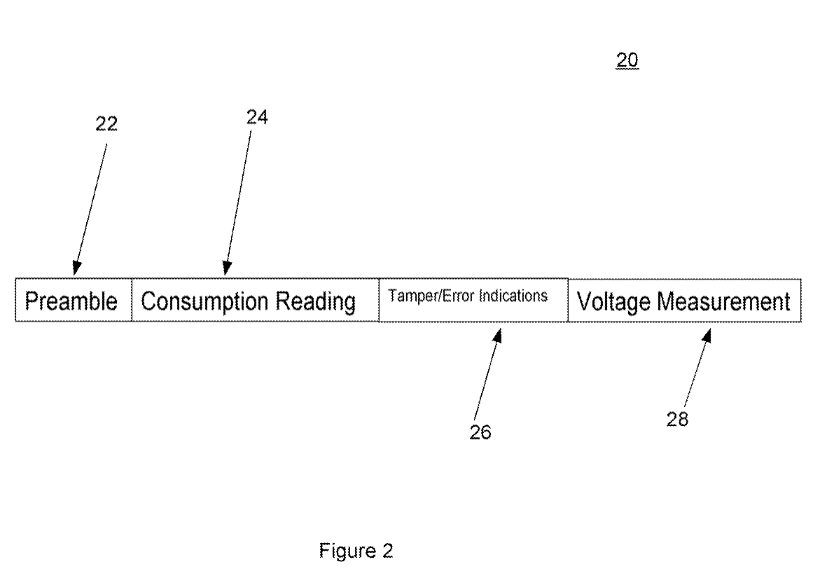

FIG. 2 shows one example block diagram of a data transmission 20 that includes consumption, status indicators, and voltage measurements. The transmission 20 begins with a preamble 22 that identifies and initializes the communicating stations. Next, the consumption on reading 24 provides the usage data of the customer for billing purposes. Status Indicators 26 that indicate any system errors and/or tampering follow. Finally, the voltage measurement 28 is included that indicates the power quality at the meter.

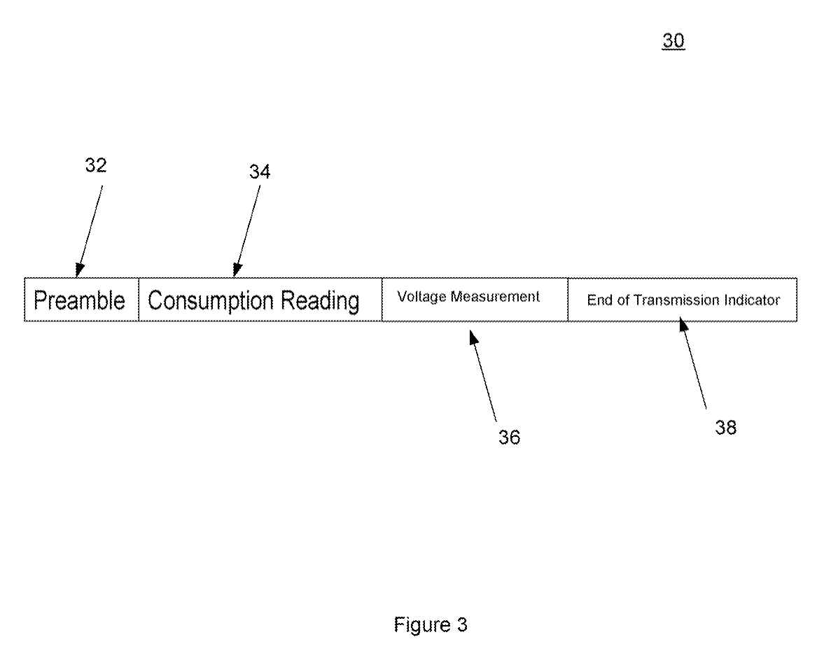

FIG. 3 shows another example of block diagram of a data transmission 30 that includes only consumption and voltage measurements. The transmission 30 begins with a preamble 32 as described previously for FIG. 2. It is followed by a consumption reading 34 and a voltage measurement 36. The last segment is an optional end of transmission indicator 38 that tells the receiving station that the transmission message is complete. It is important to understand that a comparison of the examples shown in FIGS. 2 and 3 indicate the flexibility of the present invention. In addition to voltage measurements, the utility has the option of including a wide variety of supplemental information from the meter.

In some examples, the voltage level is a real-time measurement that measures the voltage at the meter from a range of 0-552 Volts. This will cover the standard typical voltage range that may be present for residential customers. Any measurement that falls outside this range, may be represent as a “High” or “Low” reading. This range may be adjusted for non-residential customers who have different needs. For measurements in this range, the voltage is typically represented to the nearest volt. In some embodiments, the voltage measurement data shown in FIGS. 2 and 3 contain a byte of data that contains 8 bits. This provides for 256 possible voltage levels for the measurement.

While the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

What is claimed is:

1. A method of transmitting electric utility data, comprising;
collecting electric usage data at a utility meter;
collecting a voltage level at the utility meter; and
transmitting the voltage level to a utility receiving station synchronous to the transmission of the electric usage data to a utility receiving station, where the voltage level and electric usage data are electronically stored in a computer readable storage device as historical data.

2. The method of claim 1, where the voltage level is a root mean square value.

3. The method of claim 1, where the voltage level is a peak value.

4. The method of claim 1, further comprising:
collecting supplemental utility information at the utility meter.

5. The method of claim 1, where the supplemental utility information is combined with the voltage level to form a combined data message.

6. The method of claim 1, where the electric usage data is combined with the voltage level to form a combined data message.

7. The method of claim 6, where the combined data message is transmitted via a radio signal.

8. The method of claim 7, where the combined data message is transmitted to single piece of reading equipment.

9. The method of claim 8, where reading equipment is a fixed receiver.

10. The method of claim 8, where reading equipment is a mobile receiver.

11. The method of claim 1, where the voltage level in the combined data message is 8 bits long.

12. The method of claim 1, where the voltage level is measured over a range of 0-552 volts.

13. The method of claim 1, where the utility receiving station maintains a historical record of the voltage level.

14. The method of claim 1, further comprising:
collecting a supplemental status indicator at the utility meter; and
combining the supplemental status indicator into the combined data message.

15. The method of claim 14, where the supplemental status indicator comprises an error indicator for the meter.
